(19) United States
(12) Patent Application Publication
(10) Pub. No.: US 2016/0072358 A1
(43) Pub. Date: Mar. 10, 2016

(54) ENERGY STORE AND DEVICE FOR AN UNINTERRUPTED SUPPLY OF ENERGY

(71) Applicant: HITZINGER GMBH, Linz (AT)

(72) Inventors: Helmut ROLAND, Linz (AT); Christian BILL, Wels (AT)

(73) Assignee: Hitzinger GmbH, Linz (AT)

(21) Appl. No.: 14/785,886

(22) PCT Filed: Apr. 22, 2014
(86) PCT No.: PCT/AT2014/050097

§ 371 Date: Oct. 21, 2015

(30) Foreign Application Priority Data
Apr. 22, 2013 (AT) A50276/2013

(51) Int. Cl. H02K 5/173; H02J 9/00

(52) U.S. Cl. CPC H02K 5/1732; H02J 9/00

(57) ABSTRACT

A device for an uninterrupted supply of energy and an energy store for kinetic energy include a housing, a shaft which has a non-rotatably connected inner rotor, and an outer rotor, in particular a drum-shaped outer rotor, which surrounds the inner rotor at least in some areas and which is rotatably mounted relative to the shaft, the inner and/or outer rotor having at least one electric coil. The outer rotor, which is rotatably supported on the housing in a mechanical manner on both sides, is held without mechanical support towards the shaft.

### TECHNICAL FIELD

The invention relates to an energy storage device for kinetic energy, having a housing, having a shaft that has an inner rotor connected in torque-proof manner, and having an outer rotor, particularly a drum-shaped rotor, which surrounds the inner rotor at least in certain regions, and which is mounted so as to rotate relative to the shaft, wherein the inner and/or outer rotor has/have at least one electric coil.

### STATE OF THE ART

From the state of the art, storage devices for kinetic energy (DE6020040023830T2) are known, which are used, for example, in UPS systems for stabilization of the speed of rotation of a generator shaft. This energy storage device has a housing, a shaft, an inner rotor of an electric machine mounted in the shaft in torque-proof manner, and a drum-shaped outer rotor, which is mounted on the shaft, on both sides, so as to rotate. The outer rotor is kept at a speed of rotation that is elevated as compared with the inner rotor or the shaft. In the event of a power failure or variations in the speed of rotation of the shaft, the kinetic energy stored in the outer rotor is used for stabilization of the speed of rotation. In order to bring the outer rotor up to the speed of rotation, an electric coil is provided on the inner rotor, which coil generates a magnetic flow that closes over the two rotors. Furthermore, this coil or an additional coil on the inner rotor can be used for braking of the outer rotor, in order to extract kinetic energy from the latter. It is true that this embodiment of an energy storage device can guarantee compact construction conditions by means of design nesting of inner and outer rotor, but it requires comparatively great design effort in the layout of the mechanical mounting of the rotating parts. This is because in the case of energy storage devices, such a layout must satisfy the aspects of extended periods of operation and at most short shut-down times. The latter also has a negative effect in connection with the maintenance effort—known designs therefore cannot achieve great maintenance-friendliness with regard to the mechanical mounting of the rotating parts.

### PRESENTATION OF THE INVENTION

The invention has therefore set itself the task, proceeding from the state of the art as described initially, of modifying the design of an energy storage device to the effect that in spite of a compact construction, reduced design and maintenance effort exists. Furthermore, the energy storage device is supposed to be able to ensure great stability.

The invention accomplishes the set task in that the outer rotor, which is mechanically mounted on the housing, on both sides, so as to rotate, is held in mechanically bearing-free manner toward the shaft.

If the outer rotor is mechanically mounted on the housing, on both sides, so as to rotate, it is possible to do without mounting of the outer rotor on rotating parts of the energy storage device, and thereby the rotor can be held in mechanically bearing-free manner toward the shaft. Therefore the mounting of the outer rotor can be characterized in contrast to the state of the art having a fixed bearing part—for example in the form of a fixed raceway element or fixed inner or outer rings of a roller bearing. Thus, according to the invention, reduced design prerequisites can be achieved at the mounting locations of the outer rotor, the mechanical bearings of which now do not have to carry away a relative speed of rotation between their outer parts. Furthermore, in this way the speed of rotation of the cage of the roller bearings can be reduced—thereby making it possible, for example, as a further consequence, to operate the bearing in its standard use, with a fixed bearing part. In particular, however, this circumstance can be utilized to ensure interruption-free operation of the energy storage device. This is because the fixed bearing part of the mounting of the outer rotor permits maintenance, particularly subsequent lubrication, even during operation of the energy storage device, so that even at these bearing locations, which are subject to relatively great mechanical stress, increased stability can be achieved. Great periods of operation can thereby be reliably guaranteed by the energy storage device. Furthermore, due to mounting of the outer rotor on the housing, easy accessibility to the bearing locations can be utilized for measurement purposes, in order to thereby reduce the maintenance effort, for example.

The energy storage device can be simplified in terms of design in that the outer rotor ends in hollow shafts through which the shaft projects in mechanically bearing-free manner. Furthermore, this can facilitate assembly of the energy storage device, particularly since these hollow shafts can also permit simple placement of a fixed/loose mounting, in terms of design.

It is advantageous that these hollow shafts on both sides can serve as bearing locations, in that the two hollow shafts are mounted on the housing so as to rotate, by way of at least one rotor bearing, particularly a roller bearing, in each instance. Furthermore, in this way a rotatable connection with the housing can be created, which connection can particularly withstand mechanical stress.

Compact construction conditions can occur if the outer rotor is mounted so as to rotate on both side walls of the housing. Furthermore, the side walls of the housing can ensure a mechanical connection that can withstand stress, to absorb bearing forces.

If the shaft is furthermore also mounted on the housing so as to rotate mechanically, a common bearing location can be made available for the parts of the energy storage device that can rotate independent of one another, which location can contribute to improved reciprocal support of the mounting of shaft or inner rotor and outer rotor. The stability of the energy storage device can thereby be increased, according to the invention.

Mounting of the outer rotor on both sides can become less sensitive, as compared with bearing ply on the shaft, in that the rotor bearings of the outer rotor are disposed between the shaft bearings of the shaft. Furthermore, in this manner assembly of the energy storage device can be facilitated.

If at least one rotor bearing, particularly a roller bearing, provided between outer rotor and housing is connected with a line that has lubricant, active bearing lubrication can be achieved, in order to thereby increase the useful lifetime of the mounting of the outer rotor. The stability of the energy storage device can thereby be increased. Furthermore, it is not necessary to shut off the energy storage device for maintenance purposes, and as a result, once again long operating times can be guaranteed.

This active lubrication can be made possible, for example, in that the line is part of a device for oil lubrication.

Alternatively, the line can end in an opening, particularly in a nipple for grease lubrication, outside of the housing, in order to be able to undertake this active lubrication manually, as needed.

Simplifications in the design for the rotational drive of the outer rotor can result from the fact that the energy storage device has a segment motor, and the housing of the energy storage device has an opening for the segment motor. This is because access to the outer rotor can open up by way of this opening, which access can be used to drive the outer rotor or to bring it to its predetermined speed of rotation. For this purpose, the stator, which has at least one electric coil, merely has to be set into the opening of the housing, so as to interact with the outer rotor to form a segment motor. Therefore the inner rotor can be relieved of its task of accelerating the outer rotor as a kinetic energy storage device, and this can not only lead to a compact construction of the inner rotor, but also can reduce the electrical design effort at the inner rotor. The inner rotor therefore exclusively needs to carry the electric coil for magnetic coupling with the outer rotor, in order to derive kinetic energy from the outer rotor and to transfer it to the shaft. No further electrical measures are required on the inner rotor for its acceleration.

Furthermore, by means of shifting of these electrical parts from the inner rotor toward the housing, these parts can be cooled in improved manner and thereby their stability can be increased. Furthermore, a frequency inverter can be connected in simple manner, in terms of design, with such a segment motor, which is easily accessible from the outside with regard to its electrical side. Regulation of the speed of rotation of the outer rotor, particularly taking into consideration load-dependent consumer situations, can thereby be implemented in comparatively simple manner in this way. Furthermore, these simplified electrical design conditions can increase the stability of the energy storage device.

If the opening is disposed at the peak of the housing mantle, the segment motor can also be used for mechanical stress relief of the mounting of the outer rotor. The stability of the energy storage device can be increased by this measure.

It is advantageous that the energy storage device can be used in an apparatus for an uninterruptible power supply, which apparatus has an electric machine, the machine shaft of which is connected with the shaft of the energy storage device. In this way, the speed of rotation of the machine shaft can be stabilized, for example, when the electric machine is in generator operation.

If the apparatus additionally has an internal combustion engine and a coupling that is provided between electric machine and the internal combustion engine, the energy storage device can be used to stabilize the speed of rotation of the machine shaft until the internal combustion engine is engaged. A particularly stable apparatus or an uninterruptible power supply (UPS) can thereby be guaranteed.

### BRIEF DESCRIPTION OF THE DRAWINGS

In the figures, the object of the invention is shown in greater detail, using an exemplary embodiment. These show:

FIG. 1 a schematic side view of the apparatus for an uninterruptible power supply,

FIG. 2 a tear-away side view of the energy storage device of FIG. 1, and

FIG. 3 a sectional view according to in FIG. 2.

### WAY TO IMPLEMENT THE INVENTION

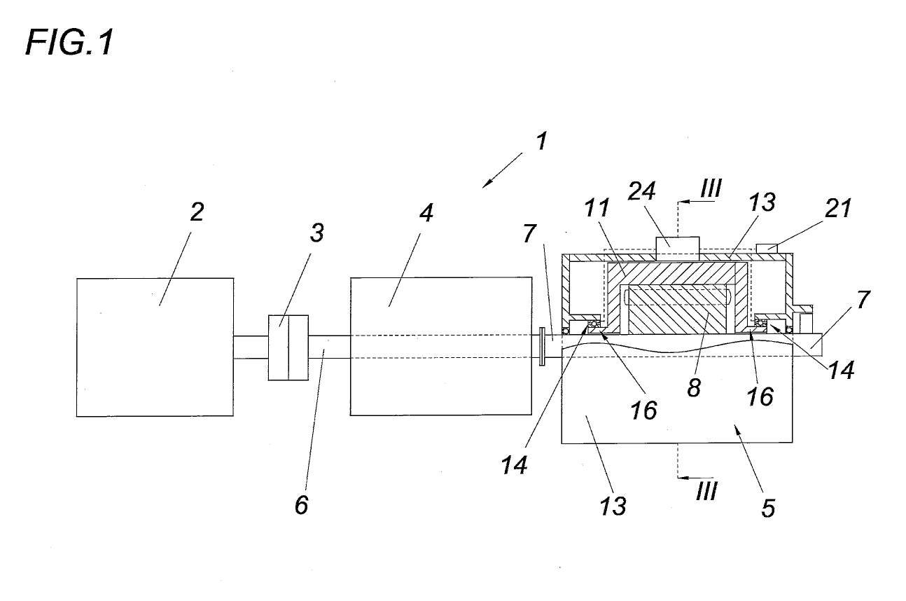

The apparatus 1 shown as an example according to FIG. 1, for an uninterruptible power supply, has an internal combustion engine 2, an electromagnetic coupling 3, and electric machine 4, and an energy storage device 5 for kinetic energy. The energy storage device 5 serves to stabilize the speed of rotation of the machine shaft 6 of the electric machine 4, and thereby to guarantee that the electric machine 4, which works as a generator, can make the required electrical characteristic data available free of variations in the event of a failure of the power grid. Thereby an uninterruptible power supply can be ensured. In the event of a power failure, the internal combustion engine 2 is brought to a speed of rotation, and after this speed of rotation is reached, engaged by way of the coupling 3, in order to be able to compensate a more extended electrical power failure, in terms of time, than would be possible by means of the kinetic energy stored by the energy storage device 5. The electromagnetic coupling 3 is flanged onto one end of the machine shaft 6 of the electric machine 4.

The energy storage device 5, with its shaft 7, is connected with the other end of the machine shaft 6 of the electric machine 4. Possibly, an elastic coupling, not shown in any detail, can also be provided between the energy storage device 5 and the electric machine 4, for power transmission.

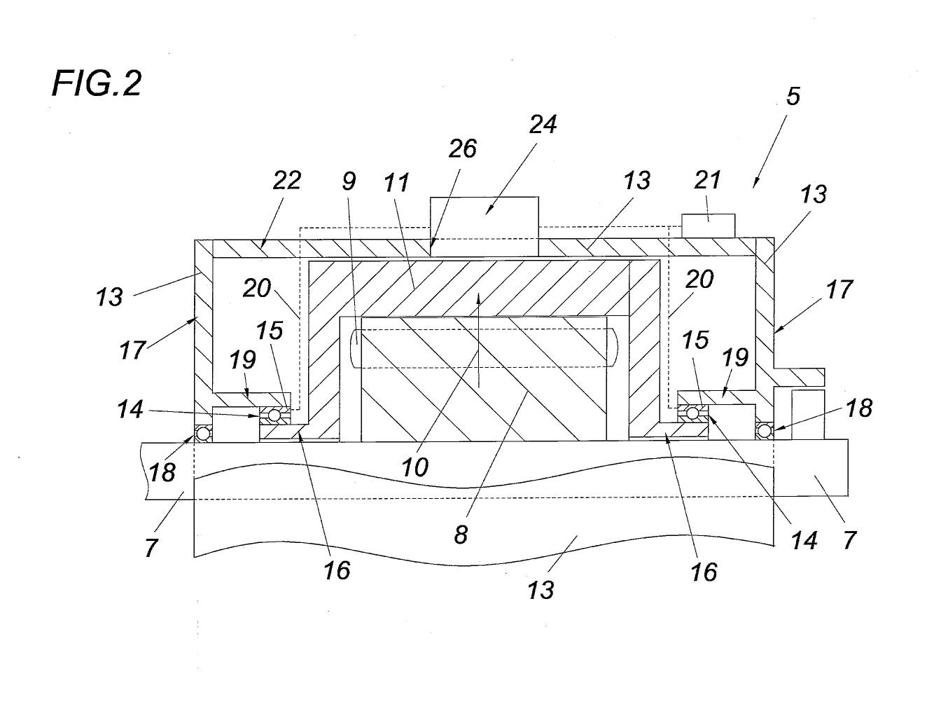

As can be derived in detail from FIG. 2 with regard to the energy storage device 5, this device has an inner rotor 8 disposed on the shaft 7 in torque-proof manner, which rotor carries an electric coil 9. This coil 9 generates a magnetic flow 10 in the inner rotor 8, which flow closes to form a magnetic circuit 12, by way of the outer rotor 11. The outer rotor 11, which is configured in pot shape and as a solid body, is disposed around the inner rotor 8 and acts in the manner of a short-circuit cage, thereby forming a force connection between the two rotors 8, 11, which connection is known for electric machines, by means of coupling their magnetic fields. Because the outer rotor 11 is mounted so as to rotate relative to the shaft 7, it can also be brought to an increased speed of rotation, as compared with the shaft 7, in order to thereby store kinetic energy. In this way, a relative speed of rotation between inner rotor 8 and outer rotor 11 also occurs.

In spite of this relative speed of rotation, stable and cost-advantageous mounting of the outer rotor is achieved in that the outer rotor 11 is mechanically mounted on the housing 13, on both sides, so as to rotate, using rotor bearings 14, here roller bearings. In this way, it is possible to do without mechanical mounting toward the shaft or toward the inner rotor 8, and this allows mounting of the outer rotor 11 using fixed bearing parts 15. Thus, lubrication of the roller bearings 14 can be undertaken even during operation of the energy storage device 5, and this ensures a long period of operation and great stability.

The outer rotor 11 ends in hollow shafts 16 on both sides. The shaft 7 projects through these hollow shafts 16 in mechanically bearing-free manner, and this creates encapsulation of the inner rotor 8, for its protection.

Furthermore, these hollow shafts 16 offer sufficient space for the rotor bearings 14 or roller bearings to engage, in order to form a fixed/loose mounting of the outer rotor 11 in the housing 13. As can particularly be seen in FIG. 2, both hollow shafts 16 are thereby mounted on the housing 13 in mechanically rotatable manner, each by way of a roller bearing.

The mounting of the outer rotor 11 on the housing 13 engages on the side walls 17 of the latter, and this creates particularly advantageous reciprocal support of the rotatable parts of the energy storage device 5, taking into consideration the shaft bearings 18 or roller bearings that also engage mechanically here.

The rotor bearings 14 of the outer rotor 11 are disposed between the two shaft bearings 18 of the shaft. For this purpose, the housing 13 projects relative to the outer rotor, with a crosspiece 19 in each instance.

A line 20 that conducts lubricant is connected with a rotor bearing 14 of the outer rotor 11 or its fixed bearing part 15. In this way, the rotor bearing 14 or roller bearing is actively lubricated, specifically using a device 21 for oil lubrication or grease lubrication. For grease lubrication, the device 21 can also be configured as a nipple, not shown, to which a grease press can be applied.

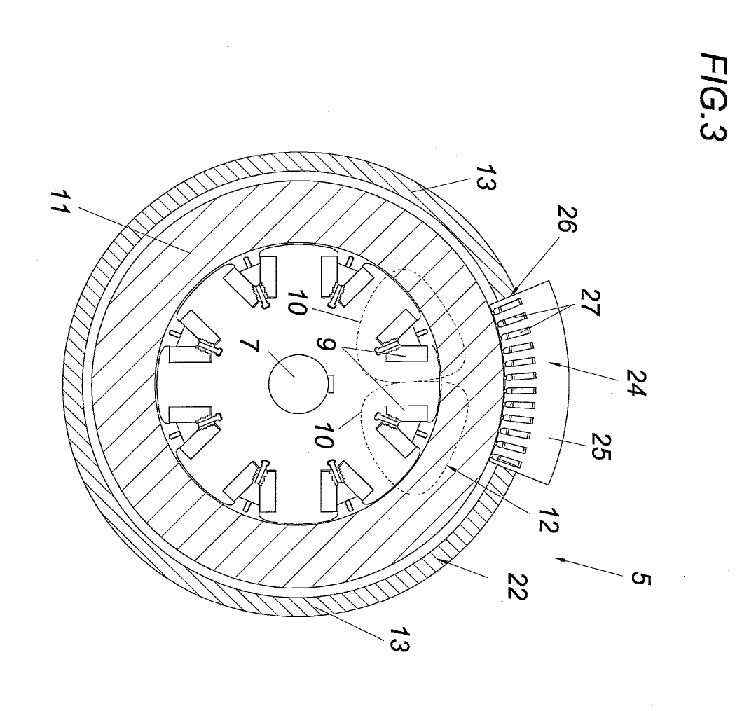

Furthermore, it can be seen in FIG. 3 that the inner rotor 8 has the rotor form of a salient pole machine, which further reduces the design effort at the energy storage device 5. In general, it should be mentioned that any rotor form is possible for the inner rotor 8.

The coil 9 on the inner rotor 8 is used as a brake coil.

The outer rotor is brought to speed of rotation using a segment motor 24, which motor is configured between a stator 25 and the outer rotor 11. For this purpose, the housing 13 of the energy storage device 5 has an opening 26 into which the stator 25 is inserted with its electric coil 27, as can be better seen in FIG. 3. The inner rotor 8 therefore works as an electric synchronous machine—the outer rotor 11 therefore works as an asynchronous machine.

This opening 26 is furthermore disposed at the peak of the housing mantle 22, in order to thereby relieve stress on the rotor bearings 14 of the outer rotor 11.

1. Energy storage unit for kinetic energy, having a housing (13), having a shaft (7) that has an inner rotor (8) connected in torque-proof manner, and having an outer rotor (11), particularly a drum-shaped rotor, which surrounds the inner rotor (8) at least in certain regions, and which is mounted so as to rotate relative to the shaft (7), wherein the inner (8) and/or outer rotor (11) has/have at least one electric coil (9), wherein the outer rotor (11), which is mechanically mounted on the housing (13), on both sides, so as to rotate, is held in mechanically bearing-free manner toward the shaft (7).

2. Energy storage device according to claim 1, wherein the outer rotor (11) ends in hollow shafts (16) through which the shaft (7) projects in mechanically bearing-free manner.

3. Energy storage device according to claim 2, wherein the two hollow shafts (16) are mounted on the housing (13) so as to rotate, by way of at least one rotor bearing (14), particularly a roller bearing, in each instance.

4. Energy storage device according to claim 1, wherein the outer rotor (11) is mounted on both side walls of the housing (13) so as to rotate.

5. Energy storage device according to claim 1, wherein the shaft (7) is mounted on the housing (13) in mechanically rotatable manner.

6. Energy storage device according to claim 5, wherein the rotor bearings (14) of the outer rotor (11) are disposed between the shaft bearings (18) of the shaft (7).

7. Energy storage device according to claim 1, wherein at least one rotor bearing (14), particularly a roller bearing, provided between outer rotor (11) and housing (13) is connected with a line (20) that has lubricant for active bearing lubrication of the rotor bearing.

8. Energy storage device according to claim 7, wherein the line (20) is part of a device for oil lubrication.

9. Energy storage device according to claim 7, wherein the line (20) ends in an opening, particularly in a nipple for grease lubrication, outside of the housing (13).

10. Energy storage device according to claim 1, wherein the energy storage device (5) has a segment motor (24), and the housing (13) of the energy storage device (5) has an opening (26) for the segment motor (24), wherein the stator (25) of the segment motor (24), which stator has at least one electric coil (9), is set into the opening (26) of the housing (13) and interacts with the outer rotor (11) to form a segment motor (24).

11. Energy storage device according to claim 10, wherein the opening (26) is disposed at the peak of the housing mantle (22).

12. Apparatus for an uninterruptible power supply, having an electric machine (4) and having an energy storage device (5) according to claim 1, wherein the shaft (7) of the energy storage device (5) is connected with the machine shaft (6) of the electric machine (4).

13. Apparatus according to claim 12, wherein the apparatus has an internal combustion engine (2) and a coupling (3), which is provided between electric machine (4) and the internal combustion engine (2).
